(19) United States
(12) Patent Application Publication
(10) Pub. No.: US 2010/0138650 A1
(43) Pub. Date: Jun. 3, 2010

(54) SECURE COMMUNICATION SYSTEM, GATEWAY APPARATUS AND ITS OPERATING METHOD

(76) Inventors: Shin Yuk KANG, Daejeon (KR); Moonok CHOI, Daejeon (KR); Il Woo LEE, Daejeon (KR); Ho Jin PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/505,828

(22) Filed: Jul. 20, 2009

(30) Foreign Application Priority Data
Dec. 1, 2008 (KR) 10-2008-0120798
Apr. 13, 2009 (KR) 10-2009-0031759

(51) Int. Cl. H04L 9/32; G06F 15/16; H04L 29/06; H04L 9/30; H04L 9/14

(52) U.S. Cl. 713/153; 726/12; 713/170; 380/44

(57) ABSTRACT

A secure communication system includes: an external peer terminal for generating a security group and participating in the security group by connecting to a peer-to-peer (P2P) network; and a legacy terminal connected to a local area network. The system further includes a gateway apparatus, connected to both of the P2P network and the local area network, for enabling the legacy terminal to participate in the security group.

### CROSS-REFERENCE(S) TO RELATED APPLICATION

The present invention claims priority of Korean Patent Application No. 10-2008-0120798, filed on Dec. 1, 2008 and Korean Patent Application No. 10-2009-0031759, filed on Apr. 13, 2009, which are incorporated herein by reference.

### FIELD OF THE INVENTION

The present invention relates to a secure communication system, gateway apparatus and its operating method, and more particularly, to a secure communication system for supporting secure communication between a peer-to-peer (P2P) network and a local or personal area network, and a gateway apparatus for the system and its operating method for generating a security group and supporting participation in the security group.

### BACKGROUND OF THE INVENTION

As well-known in the art, a virtual security group is created to share content or data a P2P network, in which the content or data is shared between terminals that have participated in the group.

To this end, a P2P framework or P2P software is required to create a security group and participate in the group by accessing a P2P network. Therefore, an external peer terminal equipped with such P2P framework or P2P software can receive a variety of services by participating in the security group on the P2P network.

However, since a legacy terminal or device that has no computing resource or has insufficient computing resource cannot be equipped with the P2P framework or P2P software, it cannot use or receive services via the P2P network. Examples of such a legacy terminal include a network printer, a network camera, a network digital picture frame, a network speaker, and so on which can connect to a local area network.

### SUMMARY OF THE INVENTION

Therefore, the present invention provides a secure communication system which enables a legacy terminal to participate in a security group on a P2P network as long as the terminal can connect to a local area network even if it has no computing resource or has insufficient computing resource.

The present invention further provides a gateway apparatus which supports that a legacy terminal that is connected to a local area network can participate in a security group on a P2P network, and its operating method.

In accordance with a first aspect of the present invention, there is provided a secure communication system, including: an external peer terminal for generating a security group and participating in the security group by connecting to a peer-to-peer (P2P) network; a legacy terminal connected to a local area network; and a gateway apparatus, connected to both of the P2P network and the local area network, for enabling the legacy terminal to participate in the security group.

In accordance with a second aspect of the present invention, there is provided A gateway apparatus which is connected to both of a local area network to which a legacy terminal is connected and a peer-to-peer (P2P) network to which an external peer terminal is connected.

The apparatus includes a terminal search and identification unit for transmitting a terminal search message to the local area network to search for and identify the legacy terminal; an identification (ID) generation unit for generating an ID of the identified legacy terminal; a security key generation unit for generating a security key including a private key and a public key of the legacy terminal to create an encrypted advertisement message; and a terminal information storage unit for indexing and storing information of the legacy terminal, including the ID and the security key.

The apparatus further includes an advertisement processing unit for generating an advertisement message of the legacy terminal to transmit the message to the external peer terminal, receiving a group invitation message from the external peer terminal and interpreting the group invitation message by using the private key, and providing information on a result of the interpretation to a group information management unit; and the group information management unit for storing mapping information of the security group in a mapping information storage unit when an authentication procedure of the legacy terminal is completed based on the information on the result of the interpretation made by using the private key, and transferring a service request message from the external peer terminal that is participating in the security group to the legacy terminal upon receipt of the service request message.

In accordance with a third aspect of the present invention, there is provided an operating method of a gateway apparatus which is connected to both of a local area network to which a legacy terminal is connected and a peer-to-peer (P2P) network to which an external peer terminal is connected.

The method includes: generating an advertisement message including an ID of the legacy terminal and transmitting the advertisement message to the P2P network; receiving a group invitation message transmitted to the P2P network for the external peer terminal to invite the legacy terminal to a security group on the basis of the advertisement message; storing mapping information of the security group when an authentication procedure of the legacy terminal is completed based on information on a result of interpretation of the group invitation message; and transferring a service request message for the legacy terminal from the external peer terminal to the legacy terminal based on the mapping information of the security group upon receipt of the service request message.

### BRIEF DESCRIPTION OF THE DRAWINGS

The above and other objects and features of the present invention will become apparent from the following description of preferred embodiments, given in conjunction with the accompanying drawings, in which:

FIG. 1 shows an overall network structure for explaining a secure communication system in accordance with an embodiment of the present invention;

FIG. 2 illustrates a detailed block diagram of a gateway apparatus that constitutes the secure communication system in accordance with another embodiment of the present invention; and

FIG. 3 offers a flowchart for explaining an operating method of the gateway apparatus that constitutes the secure communication system in accordance with still another embodiment of the present invention.

### DETAILED DESCRIPTION OF THE EMBODIMENTS

Hereinafter, some embodiments of the present invention will be explained in detail with reference to the accompanying drawings. In the following description, well-known constitutions or functions will not be described in detail if they would obscure the invention in unnecessary detail.

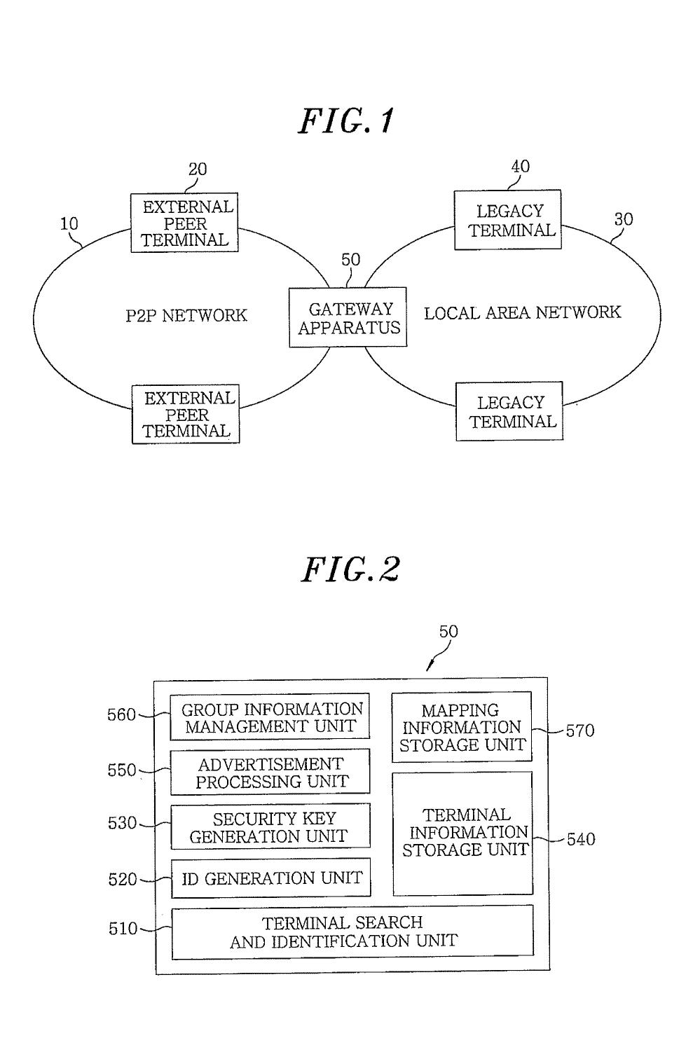

FIG. 1 shows an overall network structure for explaining a secure communication system in accordance with an embodiment of the present invention.

As shown therein, the secure communication system of the present invention includes a P2P network 10, an external peer terminal 20, a local area network 30, and a legacy terminal 40, in which the local area network 30 may be a personal area network.

The external peer terminal 20 is equipped with a P2P framework or P2P software, and can create a security group and participate in the group by connecting to the P2P network 10.

The legacy terminal 40, which has no computing resource or has insufficient computing resource because it is not equipped with a P2P framework or P2P software, can connect to the local area network 30. Examples of the legacy terminal 40 include a network printer, a network camera, a network digital picture frame, a network speaker, and so on that can connect to the local area network 30.

The gateway apparatus 50 is connected to both of the P2P network 10 and the local area network 30, and supports that the legacy terminal 40 can participate in a security group the external peer terminal 20 has created and participated.

FIG. 2 illustrates a detailed block diagram of a gateway apparatus that constitutes the secure communication system in accordance with another embodiment of the present invention.

As illustrated therein, the gateway apparatus of the present invention includes a terminal search and identification unit 510, an identification (ID) generation unit 520, a security key generation unit 530, a terminal information storage unit 540, an advertisement processing unit 550, a group information management unit 560, and a mapping information storage unit 570.

The terminal search and identification unit 510 transmits a terminal search message to the local area network 30 to search for and identify the legacy terminal 40.

The ID generation unit 520 generates an ID indicating the legacy terminal 40 searched and identified by the terminal search and identification unit 510.

The security key generation unit 530 generates a security key including a public key and a private key of the legacy terminal 40 so as to create an encrypted advertisement message.

The terminal information storage unit 540 stores information of the legacy terminal 40, including the ID and the security key, by indexing them.

The advertisement processing unit 550 encrypts the ID with the private key based on the information of the legacy terminal 40, and sends an advertisement message generated by attaching the public key thereto to the external peer terminal 20. Then, the advertisement processing unit 550 receives a group invitation message sent from the external peer terminal 20 and interprets it by using the private key.

When an authentication procedure of the legacy terminal is completed based on information on a result of the interpretation made by using the private key, the group information management unit 560 manages mapping information of the security group, and transfers a service request message to the legacy terminal 40 upon receipt thereof from the external peer terminal 20 that is participating in the security group.

The mapping information storage unit 570 stores the mapping information of the security group managed by the group information management unit 560.

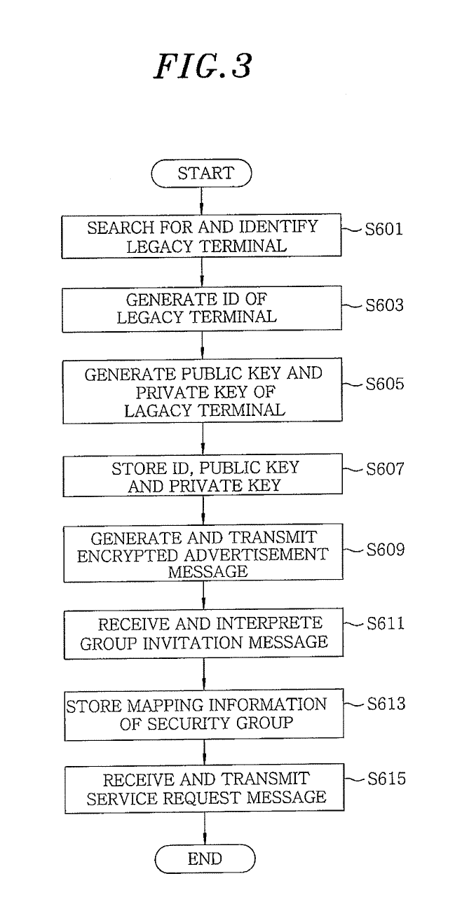

Now, a process of supporting secure communication between the external peer terminal and the legacy terminal of the secure communication system and the gateway apparatus having the configuration as above in accordance with still another embodiment of the present invention will be described in detail with reference to FIGS. 1 to 3.

First, in step S601, the terminal search and identification unit 510 of the gateway apparatus 50 sends a terminal search message to the local area network 30 to search for and identify the legacy terminal 40.

Next, in step S603, when the terminal search and identification unit 510 identifies the legacy terminal 40, the ID generation unit 520 of the gateway apparatus 50 generates an ID indicating the identified legacy terminal 40, e.g., a peer ID, and provides it to the terminal information storage unit 540 thereof. At this time, the ID generation unit 520 generates an individual ID for each legacy terminal 40 so that each legacy terminal 40 has a unique ID.

Then, in step S605, the security key generation unit 530 of the gateway apparatus 50 generates a security key including a public key and a private key of the legacy terminal 40 so as to use them in generating an advertisement message to notify the external peer terminal 20 of the legacy terminal 40. The generated security key is then provided to the terminal information storage unit 540. At this time, the security key generation unit 530 generates an individual private key for each legacy terminal 40.

Subsequently, in step S607, the terminal information storage unit 540 of the gateway apparatus 50 stores information of the legacy terminal 40, including the ID from the ID generation unit 520 and the security key from the security key generation unit 530, by indexing them.

Then, in step S609, the advertisement processing unit 550 of the gateway apparatus 50 encrypts the ID with the private key on the basis of the information of the legacy terminal 40 stored in the terminal information storage unit 540, and generates an advertisement message to notify the external peer terminal 20 of the legacy terminal 40 by attaching the public key thereto and transmits it to the P2P network 10.

The external peer terminal 20 on the P2P network 10 can identify the legacy terminal 40 based on the advertisement message transmitted from the gateway apparatus 50 on behalf of the legacy terminal 40, and transmits a group invitation message to invite the legacy terminal 40 to the security group to the P2P network 20.

Next, in step S611, the advertisement processing unit 550 receives the group invitation message transmitted from the external peer terminal 20 and interprets the message by using the private key of the legacy terminal 40 stored in the terminal information storage unit 540 to provide information on a result of the interpretation to the group information management unit 560.

When the authentication procedure of the legacy terminal is completed based on the information on the result of the interpretation made by using the private key, in step S613 the group information management unit 560 of the gateway apparatus 50 stores mapping information of the security group in the mapping information storage unit 570 for management thereof. Here, the group information management unit 560 stores mapping information of each security group for each legacy terminal 40.

Lastly, in step S615, the external peer terminal 20 that is participating in the security group can transmit a service request message for the legacy terminal 40 that is participating in the corresponding security group, and the group information management unit 560 transmits the service request message to the legacy terminal 40 based on the mapping information of the security group stored in the mapping information storage unit 570 upon receipt of the message from the external peer terminal 20.

The legacy terminal 40 receives and processes the service request message transmitted from the gateway apparatus 50 and provides its related service to the external peer terminal 20, so that the external peer terminal 20 on the P2P network 10 can receive the service provided by the legacy terminal 40 connected to the local area network 30. That is, the external peer terminal 20 on the P2P network 10 can securely transmit various data to the legacy terminal 40 on the local area network 30.

It should be noted that the number of legacy terminals managed by the gateway apparatus is not limited and the gateway apparatus belongs to two or more security groups, rather than a specific security group, for each legacy terminal to provide services.

The operating method of the gateway apparatus for secure communication in accordance with the present invention may be written with computer programs. Codes and code segments constituting the computer programs can easily be deduced by computer programmers skilled in the art. In addition, the programs are stored in a computer-readable storage medium, read and executed by computers, thereby implementing the operating method of the gateway apparatus for secure communication. Examples of the computer-readable storage medium include a magnetic recording medium, an optical recording medium, and a carrier wave medium.

In accordance with the present invention, even a legacy terminal that has no computing resource or has insufficient computing resource is allowed to participate in a security group on a P2P network as long as it can connect to a local area network. Accordingly, an external peer terminal on the P2P network can receive services offered by a legacy terminal connected to the local area network, so that it can securely transmit various data to the legacy terminal to the local area network.

While the invention has been shown and described with respect to the preferred embodiments, it will be understood by those skilled in the art that various changes and modifications may be made without departing from the scope of the invention as defined in the following claims.

What is claimed is:

1. A secure communication system, comprising:
an external peer terminal for generating a security group and participating in the security group by connecting to a peer-to-peer (P2P) network;
a legacy terminal connected to a local area network; and
a gateway apparatus, connected to both of the P2P network and the local area network, for enabling the legacy terminal to participate in the security group.

2. The secure communication system of claim 1, wherein the gateway apparatus transmits an advertisement message including an identification (ID) of the legacy terminal to the P2P network, receives and stores a group invitation message from the external peer terminal, and receives a service request message from the external peer terminal and transfers the service request message to the legacy terminal.

3. The secure communication system of claim 2, wherein the gateway apparatus encrypts the ID with a private key of the legacy terminal and attaches a public key of the terminal to encrypted information to generate the advertisement message.

4. The secure communication system of claim 2, wherein the gateway apparatus interprets the group invitation message by using the private key of the legacy terminal.

5. The secure communication system of claim 2, wherein the gateway apparatus enables one or more legacy terminals to participate in the security group.

6. The secure communication system of claim 2, wherein the gateway apparatus enables the legacy terminal to participate in one or more security groups.

7. A gateway apparatus which is connected to both of a local area network to which a legacy terminal is connected and a peer-to-peer (P2P) network to which an external peer terminal is connected, comprising:
a terminal search and identification unit for transmitting a terminal search message to the local area network to search for and identify the legacy terminal;
an identification (ID) generation unit for generating an ID of the identified legacy terminal;
a security key generation unit for generating a security key including a private key and a public key of the legacy terminal to create an encrypted advertisement message;
a terminal information storage unit for indexing and storing information of the legacy terminal, including the ID and the security key;
an advertisement processing unit for generating an advertisement message of the legacy terminal to transmit the message to the external peer terminal, receiving a group invitation message from the external peer terminal and interpreting the group invitation message by using the private key, and providing information on a result of the interpretation to a group information management unit; and
the group information management unit for storing mapping information of the security group in a mapping information storage unit when an authentication procedure of the legacy terminal is completed based on the information on the result of the interpretation made by using the private key, and transferring a service request message from the external peer terminal that is participating in the security group to the legacy terminal upon receipt of the service request message.

8. The gateway apparatus of claim 7, wherein the ID generation unit generates an individual ID for each legacy terminal, and
the security key generation unit generates an individual private key for each legacy terminal.

9. The gateway apparatus of claim 7, wherein the mapping information storage unit stores the mapping information for each security group of each legacy terminal.

10. An operating method of a gateway apparatus which is connected to both of a local area network to which a legacy terminal is connected and a peer-to-peer (P2P) network to which an external peer terminal is connected, comprising:
generating an advertisement message including an ID of the legacy terminal and transmitting the advertisement message to the P2P network;
receiving a group invitation message transmitted to the P2P network for the external peer terminal to invite the legacy terminal to a security group on the basis of the advertisement message;
storing mapping information of the security group when an authentication procedure of the legacy terminal is completed based on information on a result of interpretation of the group invitation message; and
transferring a service request message for the legacy terminal from the external peer terminal to the legacy terminal based on the mapping information of the security group upon receipt of the service request message.

11. The operating method of claim 10, further comprising:
encrypting the ID with a private key of the legacy terminal and attaching a public key of the terminal to encrypted information to generate the advertisement message.

12. The operating method of claim 10, further comprising:
interpreting the group invitation message by using the private key of the legacy terminal.
